(19) United States
(12) Patent Application Publication
(10) Pub. No.: US 2025/0131456 A1
(43) Pub. Date: Apr. 24, 2025

(54) IMPLEMENTATION METHOD FOR PAPER-BASED VISUALLY IDENTIFIABLE ANTI-COUNTERFEITING ELECTRONIC SEAL

(71) Applicant: YIQING ZHANG, Jinhua (CN)

(72) Inventors: WENGUANG ZHANG, Jinhua (CN); YIQING ZHANG, Jinhua (CN)

(21) Appl. No.: 19/001,359

(22) Filed: Dec. 24, 2024

Related U.S. Application Data
(63) Continuation of application No. PCT/CN2023/105476, filed on Jul. 3, 2023.

(30) Foreign Application Priority Data
Jul. 6, 2022 (CN) 202210789920.0
Nov. 19, 2022 (CN) 202211450403.7
Jul. 1, 2023 (CN) 202310796130.X

(51) Int. Cl. G06Q 30/018; G06Q 50/18

(52) U.S. Cl. CPC G06Q 30/018; G06Q 50/18

(57) ABSTRACT

An implementation method for a paper-based visually identifiable anti-counterfeiting electronic seal is achieved through functional software that is configured with an authentication communication interface. An electronic seal pattern includes a fixed information part and a dynamic information part, and the later includes an associated code of stamped sample and an associated code of authorized counterpart. An operator needs to provide a communication tool number of an authorized counterpart, serving as an associated code to be embedded into the seal pattern for intuitive display. The software binds the code to stamped samples, permitting the authorized counterpart to authenticate, extract, or consult the samples through a communication tool. Using the authentication communication interface, the authorized counterpart can perform anti-counterfeiting verification on the stamped samples.

CROSS-REFERENCE RELATED REFERENCE

This application is a continuation of PCT/CN2023/105476, filed Jul. 3, 2023 and claims priorities of the Chinese Patent Application No. 202210789920.0, filed on Jul. 6, 2022, the Chinese patent application with the application Ser. No. 202211450403.7, filed on Nov. 19, 2022, and the Chinese patent application with the application Ser. No. 202310796130.X, filed on Jul. 1, 2023, the entire contents of which are incorporated herein by reference.

### TECHNICAL FIELD

The present invention relates to an implementation method for a paper-based visually identifiable anti-counterfeiting electronic seal.

### BACKGROUND

In the era of internet economy, remote contract signing is a common economic activity. Remote unilateral stamping is also frequently required in many scenarios, for example, bidding documents need to be modified and stamped on-site, or letters of inquiry are submitted on bid opening sites, and letters of introduction are remotely issued. In response to remote stamping, there are many management challenges and loopholes in physical seals, which are not suitable for remote stamping, implying great legal and financial risks, such as the fake seal scandals involving a certain food company and a tech company, the seizing of company seals at an on-line bookstore, and the forgery of an automobile company's seal by another major enterprise. There are also phenomena such as official seal abusing and stealing, or blank stamping by seal custodians. Upon the seal being taken out, it is difficult to monitor seal usage. It is also difficult to supervise the seals of subordinate units, and if seals are used in violation of laws and regulations, it may lead to unnecessary legal liability and economic losses for superior units. When seals have to be sent remotely, it is costly, inefficient, and bears a risk of loss. The process of remote contract signing is very inconvenient and difficult to standardize. Currently, a commonly used method involves that one party scans a stamped text and sends it to the other party, who prints and stamps the scanned copy, and sends the stamped text back after being scanned, with a cumbersome process, and often resulting in poor text quality due to multiple scans. Other difficulties in physical seal management include the electronic management of stamped documents.

Over recent years, products such as smart seal machines have emerged, involving that the physical seal is placed in a smart housing with built-in IoT chips that can be remotely controlled, through remote authorization, the housing can be opened to achieve stamping, and a photograph of the stamped text is automatically taken and retained. This smart seal machine solves the problems of remote stamping and the management of seals in subsidiaries. However, it is trouble in overall operation, and very inconvenient in carrying, with the problem of seal forgery being remained.

In the era of physical seals, there is also a situation where electronic patterns of physical seals are created using word processing or graphic software. These electronic seal patterns are applied to documents in WPS or Word, and subsequently printed onto paper by means of color printers. Such situations constitute illegal imitation of various seals. Generally speaking, these documents with imitated seal patterns are not independently used as electronic files. Instead, the vast majority of them are printed onto paper to pass off as original ones. This illegally imitated anti-counterfeiting electronic seal pattern is distinguished typically relying on subtle differences between the printed color and the ink color. If color distinction fails, the background investigation of the stamped text is often required. Due to the lack of visual anti-counterfeiting functions or authorized authentication from a third-party platform to restrict its abusing, this simple electronic seal imitation is widely opposed. On the other hand, if the electronic seal patterns that have been authenticated by a third party are merely simple copies of physical seal patterns, without being endowed with the variable visual dynamic information characteristic and the convenient anti-counterfeiting authentication function possessed by genuine anti-counterfeiting electronic seals, such electronic seal patterns are still inconvenient for conversion into paper documents for circulation and use. The reason lies in the fact that the seal patterns printed onto paper documents are identical, making it extremely difficult for people to distinguish the authenticity of the seal patterns and the stamped texts. As a result, they can only resort to the authentication platform to conduct complicated electronic authenticity verification. Internet applications emphasize simple and convenient operations. However, the current electronic authenticity verification on existing on-line contract signing platforms is very complicated in operation, deterring many beginner users.

As the internet technology advances, an electronic signature method is required in social and economic life to solve the above problems. Accordingly, electronic signatures and on-line identity authentication have emerged. In 1995, Utah in the United States enacted the world's first electronic signature law. In 1996, the United Nations Commission on International Trade Law formulated the Model Law on Electronic Signatures. In 1999, the European Union issued the Directive on Electronic Signatures. In 2000, the United States Congress passed the Electronic Signatures in Global and National Commerce Act, which was electronically signed by Bill Clinton. After that, over 40 countries, including Japan, Singapore, and South Korea, also formulated laws related to electronic commerce. On Apr. 1, 2005, China's Electronic Signature Law officially went into effect. On Apr. 2, 2003, DocuSign was incorporated in Washington State, providing users with solutions of electronic signature.

In 2006, the inventor of the present invention published “Dual-Network Mode Wireless Seal Authentication” in the 9th issue of the “E-commerce” magazine, proposing for the first time the use of dynamic SMS codes to solve the difficulty of remote identity authentication. This technology has now been widely applied, with the idea thereof serving as one of the theoretical foundations for the electronic seal anti-counterfeiting authentication in the present invention.

Since 2010, over ten network platforms in China have launched third-party on-line contract signing services, roughly including BestSign, FaDaDa, Qi YueSuo, Cloud Contract, eSign, E-cloud sign, Wosign, Chinese YunSign, AnXin Sign, EnjoySign, WenSign, LinkSign, EasySign, Qianbh, etc. Quite a number of institutions, such as banks, mobile communication companies, and customs, provide externally the electronically stamped text or documents under their own management. Nevertheless, the electronic seals of these platforms or institutions only possess electronic-level anti-counterfeiting functions and lack paper-based anti-counterfeiting functions. Furthermore, such seal patterns generated are identical each time, making them vulnerable to being replicated without being detected easily.

The currently prevalent electronic seal services are, in fact, semi-functional electronic seals provided by these on-line contract signing platforms. Such electronic seals merely serve as an auxiliary product for on-line contract signing services by on-line contract signing platforms, only achieving electronic-level anti-counterfeiting functions and lacking visually anti-counterfeiting functions, or rather, lacking visually identifiable paper-based anti-counterfeiting functions. Such existing electronic seals can only be attached to electronic files in specific formats (usually PDF). The existing electronic seals printed onto paper or presented as images on electronic display media (such as webpages) completely lose their anti-counterfeiting functions, which is a key difficulty in current on-line contract signing and electronic seal applications. Lacking of paper-based anti-counterfeiting functions, the electronic seals applied in existing on-line contract signing are greatly limited in daily applications. In particular, small and medium-sized enterprises as well as individual businesses have a very low acceptance rate of the existing on-line contract signing. As of January 2023, there were over 150 million registered business entities in China, with over 50 million incorporated companies. However, the cumulative number of business entities using on-line contract signing still remains in the millions, with a popularizing rate of only around 5%. Existing on-line contract signing services are essentially value-added services for electronic seals.

Currently, there is a view prevailing in the industry that comprehensive paperless office will be inevitably in the future. In the trend of office electronization, as long as the electronic-level anti-counterfeiting issues are solved for the electronic texts, it is believed that all anti-counterfeiting problems are solved, and thus electronic seals do not need to have paper-based anti-counterfeiting functions. In fact, the widespread acceptance of this view leads to these signing platforms to pay little attention to the visual anti-counterfeiting issue in the field of electronic signatures. Actually, it is also because there are no effective solutions. The inventor of the present invention holds the view that both such predictions and conclusions are inaccurate. Firstly, a completely paperless office will not become true in the foreseeable future, because quite a number of on-line contract signing service providers still offer smart seal machines, indicating that paper-based stamped texts remains a rigid demand. Secondly, even for electronic documents, the visual identification of authenticity with the naked eye is still indispensable, with a frequency of use far exceeding that of electronic authentication. On the other hand, a large part of people in the industry even believes that paper-based anti-counterfeiting for electronic seals is impossible. This biased cognition can only be overturned after a practical technical solution is truly developed. Of course, some people in the industry are constantly exploring visual (paper-based) anti-counterfeiting technologies for electronic seals. The existing visual anti-counterfeiting technology routes for electronic seals mainly include special watermarks, special patterns, special inks, or special printers. However, there is always the possibility or even inevitability that these routes can be replicated or counterfeited. Furthermore, for these routes, since external authentication parties often do not know or have the original texture or ink standards of the authentic seal, it is actually difficult for them to determine its authenticity.

Therefore, in real social and economic life, there is an urgent need for a full-functional electronic seal to replace physical seals, to enhance the current on-line contract signing function, thereby covering on-line and off-line scenarios. Whether this goal can be achieved cannot be arbitrarily concluded with a positive or negative answer before a practical solution is implemented.

In the solution of “Intelligent Seal System” with the publication number of CN104850961A (2015102921354) disclosed on Aug. 19, 2015, the intelligent seal system can obtain information about the seal issuing unit and the issuing target by scanning a QR code. In this solution, the issuing target information is added to the QR code, lacking visual identification function. In fact, using a QR code alone does not provide anti-counterfeiting function, because it is very easy to compile information and generate a QR code that is impossible to be visually authenticated. In this solution, the issuing target information serves only as simple information display and is highly susceptible to copying and forgery, and there is a lack of convenient anti-counterfeiting verification means for forged information.

“An Electronic Seal System and Using Method Therefor” with the publication number of CN106682479A (2016111909765) disclosed on May 17, 2017 involves that, upon approval and authorization by the seal-using entity, information such as contract or document number, number of seals applied, and number of printed copies is provided to a seal formation module, so that a seal is created and then transmitted to an electronic seal key. At this point, the text file is stored in an electronic seal key memory, and the electronic seal key is displayed in the password seal shape on the stamped document, along with a password seal of legal person. The seal is applied at a suitable location on the last page of the contract or document. “An Intelligent Seal Management System” with the publication number of CN109840704A (201910080554X) disclosed on Jun. 4, 2019 introduces the use of a cloud platform to record and store the time and frequency of seal use for easy user inquiry. Two applications with the number of 2021101930440 and 202110190817X disclosed on May 7, 2021 involve the issue of visual anti-counterfeiting for electronic seals. In solutions of the two applications, the time of stamping and cumulative number of stamps are presented in the electronic seal patterns. These solutions merely address the problem of uniqueness for each stamping operation, but still fail to solve the orientation issue and the most critical problem of anti-counterfeiting verification for electronic seals.

The inventor of the present invention believes that: a seal represents an institution or an individual, and a seal also has intrinsic characteristics and external features; the seal pattern is equivalent to a person's appearance; the seal pattern or stamped sample retained by the third-party platform is equivalent to the identity card data stored in the public security organ; and the electronic signature or identity authentication data is equivalent to the DNA of an anti-counterfeiting electronic seal. The existing technical solutions have well addressed the issue of retained data and DNA, but fail to solve the problem of visual discrimination of seal patterns, and naturally, fail to solve the problem of paper-based anti-counterfeiting of electronic seals. In practical applications, visual discrimination of patterns is commonly required and highly demanded. Just as that people, in daily life, rely on appearance to identify each other, only in a few special scenarios will it come to the comparison of identity cards based on authority, and only under even more special circumstances might DNA comparison be carried out. It has been over 20 years since the birth of electronic signatures, which haven't been widely promoted and accepted. The inventor of the present invention believes that the core reason lies in the failure to solve the problem of appearance discrimination, creating a difficult-to-cross gap between electronic signatures and the vast majority of ordinary people. None of electronic anti-counterfeiting and visual anti-counterfeiting is dispensable. However, only one of them is solved by the existing third-party contract signing platforms.

In summary, electronic seal anti-counterfeiting mainly involves four aspects. Firstly, the identity authentication for seal entity, which can be solved through reliable identity authentication by a third-party platform. Secondly, the authenticity of seal pattern, which can be addressed through a multi-layered approach combining visual anti-counterfeiting seal pattern with electronic anti-counterfeiting methods on the platform, in combination with the anti-counterfeiting authentication requirements at different levels. Thirdly, the uniqueness, orientation, and prevention of illegal forgery and copying in terms of the combination of electronic seals, text content, and the counterpart, which can also be addressed through a multi-layered approach combining visual anti-counterfeiting seal pattern with electronic anti-counterfeiting methods on the platform, in combination with the anti-counterfeiting verification needs at different levels. Fourthly, the reliable and convenient anti-counterfeiting verification from external parties. Only by reasonably combining these four aspects can a truly practical and easily managed anti-counterfeiting electronic seal be created.

### SUMMARY

In response to the problems about using and authenticating electronic seals in the era of internet economy, the present invention aims to provide a reliable and convenient implementation method for a paper-based visually identifiable anti-counterfeiting electronic seal.

To achieve the above objective, the implementation method for a paper-based visually identifiable anti-counterfeiting electronic seal of the present invention is achieved through electronic seal functional software. In a case that a user needs stamping, the electronic seal functional software is operated to generate a seal pattern onto an electronic text to be stamped. The seal pattern of the paper-based visually identifiable anti-counterfeiting electronic seal includes a fixed information unit and a dynamic information unit. The fixed information unit includes one or more combinations of the following information: a seal entity name, a seal logo, a seal entity code, or a seal type name. The dynamic information unit includes an associated code of authorized counterpart. The associated code of authorized counterpart is generated through the following method: submitting communication tool number information of an authorized counterpart by an electronic seal operator to the electronic seal functional software; and using the electronic seal functional software to select some or all of the submitted communication tool number information of the authorized counterpart to form part or all of the associated code of authorized counterpart, and to fixedly present the associated code of authorized counterpart in a directly visually readable manner within the generated seal pattern or in an affiliated information area thereof.

In a preferred solution, the communication tool number is a number with exclusive identity-oriented characteristics, including a mobile phone number, an email address, or an instant messenger number, with the mobile phone number being particularly convenient and reliable. The instant messenger number includes WeChat ID, QQ number, MSN number, etc. The communication tool number with exclusive identity-oriented characteristics refer to those that have a certain degree of exclusive identity binding with a number holder or user, including some communication tool numbers that have undergone real-name authentication, such as mobile phone number, email address, QQ number, and WeChat ID. Such communication tool numbers have relatively stable and clear identity orientation, and can all be used on mobile terminals, providing the convenience of portability. In contrast, fixed telephone numbers (landline phone numbers) are excluded from the communication tool number with exclusive identity-oriented characteristics, because the people who use a particular fixed telephone number is different. Using such numbers for identity authentication is relatively inaccurate and susceptible to malicious use. Moreover, most fixed telephone numbers are not portable. Although personal handphone system previously is portable, it is bound to a landline phone, resulting in unstable identity orientation.

In a preferred solution, information in the affiliated information area and a main seal pattern are generated and displayed synchronously, and may be printed synchronously onto paper. The main seal pattern refers to the part that, according to conventional usage habits, contains information related to the seal entity, such as the seal entity name, the seal entity code, or the seal type. In a preferred solution, the affiliated information area is a rectangular information area, an annular information area outside a main pattern of a circular or oval seal, or an irregularly shaped information area. Generally speaking, the affiliated information area is located outside the main pattern information area, and the shortest distance between the affiliated information area and the main pattern information area is less than or equal to the diameter of the main pattern information area. Alternatively, the shortest distance between the affiliated information area and the main pattern information area is less than or equal to the length of the widest contour of the main pattern information area. The dynamic information unit can also include two or more sets of associated codes of authorized counterpart.

Further, the electronic seal functional software preserves a seal pattern sample, a stamped information summary, or stamped text formed after a stamping operation, the seal pattern sample, the stamped information summary, or the stamped text being collectively referred to as stamped samples; the electronic seal functional software is configured with an electronic seal authentication communication interface; the electronic seal functional software authenticates and associates a communication tool number serving as the information source basis for the associated code of authorized counterpart with the stamped samples, or, the electronic seal functional software authenticates and associates the acquired communication tool number information of the authorized counterpart with the stamped samples; and by recognizing the authenticated and associated communication tool number information operated by the authorized counterpart, the electronic scal functional software grants the authorized counterpart the right to actively initiate authentication, extraction, or consultation for the stamped samples of this time or this batch.

The actively initiated rights of authentication, extraction, or consultation are fundamentally distinct from the current on-line contract signing notification message sent by on-line contract signing platforms to signing counterparts, primarily manifesting in the following aspects. Firstly, their functions and purposes are different: existing contract signing notification message serves to notify signing counterparts to complete on-line contract signing procedures, while the actively initiated authentication, extraction, or consultation behaviors in the present invention are primarily for authenticity verification. Secondly, their operational workflows are different: existing on-line contract signing message is first generated by a signing platform and sent to signing counterparts to notify them for on-line contract signing, and the signing counterpart passively receives and responds to related procedures; while the authentication, extraction, or consultation behaviors of the present invention are actively initiated by the authorized counterpart at any time, and then the platform approves or denies the request; and possessing means for actively initiating anti-counterfeiting authentication serves as a basic requirement for digital anti-counterfeiting authentication. Thirdly, their anti-counterfeiting effects are different: the active authentication, extraction, or consultation functions enable the authorized counterpart with active anti-counterfeiting authentication means for stamped samples, making forgery undeniable; while the mobile phone numbers for receiving existing signing notification message are not authenticated and associated with the stamped text, thus lacking the autonomous anti-counterfeiting authentication function. Fourthly, the existing signing notification message is unable to extract unilaterally stamped texts; in a case that a counterpart receives a signing message but does not respond to it, the signing process remains suspended and the next step cannot be performed; while the solution of the present invention enables authorized counterpart to achieve autonomous and active authentication, extraction, or consultation for unilateral, bilateral, and multilateral stamped samples. Fifthly, and most important, the mobile phone numbers for receiving the existing signing notification message are not displayed within the seal pattern or the affiliated information area thereof, resulting in existing electronic seals lacking both orientation and off-line authenticability, and even lacking paper-based anti-counterfeiting functionality.

Further, the authentication, extraction or consultation method for the stamped samples is as follows. The authorized counterpart utilizes or operates the communication tool number authenticated and associated with the stamped samples or the communication tool number serving as the information basis for the associated code of authorized counterpart to establish communication with the electronic seal functional software through the electronic seal authentication communication interface, and make a request for authentication, extraction, or consultation of the stamped samples; and upon receiving the request, the electronic seal functional software extracts the communication tool number information through which the request is proposed by the authorized counterpart, and determines whether there are stamped samples authenticated and associated with this number information, to decide whether to grant the request.

In a preferred solution, the dynamic information unit further includes an associated code of stamped sample, and the associated code of stamped sample is generated through the following method. During the stamping operation of the electronic seal, the electronic seal functional software is employed to automatically generate the associated code of stamped sample, and fixedly present the generated associated code of stamped sample in a directly visually readable form within the generated seal pattern. Alternatively, the electronic seal functional software acquires the time information during the stamping operation and fixedly presents the acquired time information in a directly readable form within the generated seal pattern, forming part or all of the dynamic information unit. In a preferred solution, the electronic seal functional software uses the acquired time information as the basis information for generating the associated code of stamped sample. In another preferred solution, both the time information during the stamping operation and the associated code of stamped sample are simultaneously presented in a directly readable form within the generated seal pattern, forming part or all of content of the dynamic information unit.

The preferred method for authentication, extraction or consultation of stamped samples is as follows. The authorized counterpart utilizes or operates the communication tool number authenticated and associated with the stamped samples or the communication tool number serving as the information basis for the associated code of authorized counterpart to establish communication with the electronic seal functional software through the electronic seal authentication communication interface, and make a request for authentication, extraction, or consultation of the stamped samples, with the request information including associated information of seal entity, the associated code of stamped sample, or a combination of the two. Upon receiving the request, the electronic seal functional software extracts the communication tool number information through which the request is proposed by the authorized counterpart, and searches a database for stamped samples matching the above-mentioned associated elements in combination with the associated information of seal entity, the associated code of stamped sample, or the combination of the two submitted by the authorized counterpart. If a match is found, the request is granted. Otherwise, the request is denied. In the process, a necessary condition for approving a request is that the communication tool number information provided by the authorized counterpart matches the communication tool number information of the authorized counterpart authenticated and associated with the stamped sample in the database. The establishing communication through the electronic seal authentication communication interface with the electronic seal functional software includes, but is not limited to, the following scenarios: dialing the phone number of the electronic seal authentication communication interface, sending a message to the electronic seal authentication communication interface, sending an email to the electronic seal authentication communication interface, accessing the official WeChat account of the electronic seal authentication communication interface, logging into the website of the electronic seal authentication communication interface, etc. The associated information of seal entity refers to information related to the seal entity that has identity orientation, including but not limited to the seal entity name, the seal entity code, and the seal entity abbreviation.

In the above methods, in a case that only the associated information of seal entity is included in the request information submitted by the authorized counterpart, the electronic seal functional software displays to the authorized counterpart a list of all stamped samples under the seal entity name in the database that are authenticated and associated with the exclusive communication tool number of the authorized counterpart, for selection. In a case that only the associated code of stamped sample is included in the request information submitted by the authorized counterpart, the electronic seal functional software searches the database for stamped samples that simultaneously authenticated and associated with both the exclusive communication tool number of the authorized counterpart and the associated code of stamped sample. If a match is found, the request is approved. In a case that the request information submitted by the authorized counterpart includes combined information of both the associated information of seal entity and the associated code of stamped sample, which constitute a precise authentication request, and the corresponding stamped sample must simultaneously match the exclusive communication tool number authenticated and associated with the authorized counterpart, the associated information of seal entity, and the associated code of stamped sample. The electronic seal functional software searches the database for stamped samples that meet these matching requirements. If a match is found, the request is approved.

Further, in a case that the authorized counterpart needs to delegate to another person the right of authentication, extraction or consultation of the stamped sample, the method is as follows. A sublicensor of the authorized counterpart submits a request for authentication, extraction, or consultation of stamped samples to the electronic seal functional software. The request information submitted has to include the communication tool number information authenticated and associated with the stamped samples of the authorized counterpart or the communication tool number information serving as the information basis for the associated code of authorized counterpart, and include one of the following pieces of information or a combination of both: associated information of seal entity or the associated code of stamped sample. Upon receiving the request, the electronic seal functional software extracts the communication tool number information of the authorized counterpart from the request information and searches the database for associated and matching stamped samples in combination with the associated information of seal entity, the associated code of stamped sample, or the combination of both in the request information. If matching stamped samples are found, the electronic seal functional software sends sublicense confirmation information to the communication tool number of the authorized counterpart. The authorized counterpart forwards the received confirmation information to the sublicensor, and the sublicensor uses the received confirmation information to submit a sublicense qualification matching request to the electronic seal functional software. The electronic seal functional software performs matching determination. If a match is successful, the sublicense permission is completed, and the sublicensor obtains the right to authenticate, extract, or consult the associated stamped samples. The sublicense confirmation information can be in the form of a short message dynamic verification code, or a web link and file extraction code for a stamped sample, or a specific method for the authentication, extraction, and consultation of the stamped sample.

In a preferred solution, the electronic seal functional software is an electronic seal functional software platform managed by a third-part authentication authority.

In a preferred solution, the seal pattern or the affiliated information area thereof of the paper-based visually identifiable anti-counterfeiting electronic seal further includes associated mark information or authentication communication interface information of an electronic seal authentication authority.

In a preferred solution, the paper-based visually identifiable anti-counterfeiting electronic seal is used in combination with identity authentication, electronic signatures, or timestamp technology of the seal entity, seal operator, and all related parties.

The seal entity described in claims and specification of the present invention includes natural persons, legal persons, and other organizations. The authentication in the present invention refers to the confirmation of the authenticity of a stamped sample by the audience thereof or other related parties. The authentication of stamped samples in the present invention includes, but is not limited to, the following forms: automatic comparison and authentication by the electronic seal functional software after uploading the stamped sample by the authentication requester; self-comparison and authentication by the authentication requester after extracting the stamped sample, including direct download from the backend of the electronic seal functional software or receiving a file sent by the electronic seal functional software to the authorized extractor; and on-line consultation and comparison of the stamped sample by the authentication requester. Since the extraction or consultation of stamped samples by the audience is not solely for authentication, the authentication (authentication right), extraction (extraction right), and consultation (consultation right) are regarded as parallel processes in the claims and specification of the present invention. The authentication and association with stamped sample in the present invention refers to the binding of authenticated-associated information and stamped sample when the audience of the stamped sample needs to perform authentication, extraction, or consultation operations. The authorized counterpart in the present invention refers to the natural person, legal person, or other organization authorized by the seal entity or seal operator to have authentication, extraction, or consultation rights for the stamped samples formed in the stamping event or in relation to the stamping. The authorized counterpart of the present invention is distinct from the electronic seal entity itself or the electronic seal operator, but the electronic seal operator can also serve as an authorized counterpart. For contract texts signed by two or more parties, the authorized counterparts of any seal entity include, but are not limited to, the signing counterpart (natural person, legal person, or other organization, such as if the electronic seal entity of the signing text serves as Party A, Party B, Party C, etc., are the counterparts; for example, in a labor contract, the signing unit and the laborer are counterparts to each other), authorized representatives of the signing counterpart, third parties authorized for the contract text, public authorities or other third parties legally entitled to authenticate, consult, or extract stamped samples, and other individuals authorized by the seal entity. For unilaterally stamped texts (such as authorization letters, declaration letters, official letters, notices, and announcements), the authorized counterparts include, but are not limited to, the authorized objects and specific recipients of declaration letters, official letters, notices, announcements, etc. In the solution of the present invention, when the authorized counterpart is a legal person or other organization, the actions of its authorized operational agent (authorized handler) are considered as actions of the authorized counterpart.

The directly visually readable manner in the present invention refers to the manner that relevant codes can be read without the aid of other devices or software, such as numeric codes, alphabetic codes, text codes, or mixed numeric, alphabetic, and text codes. Barcodes or QR codes are typical codes that are not directly visually readable and require corresponding electronic devices for reading before subsequent anti-counterfeiting authentication operations can be performed. During the assessment of large batches of stamped samples, the corresponding reading and evaluation actions are too complicated, making it easy to miss anti-counterfeiting authentication determination. Therefore, there is a strong demand for visually distinguishing authenticity among counterparts. In addition, the copied or forged barcodes or QR codes are not easily identified. Communication and telecommunications, as well as communication interfaces and telecommunication interfaces, have equivalent meanings in the present invention.

By setting up an authorized counterpart authentication association mechanism, the electronic seal stamped samples have specific orientation, thereby excluding non-related personnel from interfering with the authentication affairs of the stamped samples. When presenting stamping code information and ownership counterpart associated code information on the seal pattern, it is convenient to ensure that each seal pattern generated by each stamping is unique (although unique is not a rigid necessary condition of the solutions in the present invention). Therefore, illegal copying is easily exposed. Especially when presented in a directly visually readable form, it is very convenient to visually discriminate the authenticity of electronic seals, with highly reliable. For forgers, it significantly increases the difficulty of hiding flaws. In a case that the authorized counterpart utilizes or operates the authenticated and associated communication tool number (especially a mobile phone number) to conduct actual authenticity authentication, the forger will inevitably be exposed. For unauthorized individuals of this stamped sample, they cannot authenticate, extract, or consult the stamped sample because they do not have the authorized mobile phone number. Some or all of the communication tool number information of the authorized counterpart of the stamped samples are presented in the associated code of authorized counterpart within the seal pattern, preventing illegal copying of the seal pattern. If the seal pattern is copied verbatim, due to lack of corresponding authorized communication tool number information, the copier is easily exposed. Conversely, if the communication tool number information of the copier is forcibly added to the seal pattern, the identity authentication cannot be passed by the electronic seal functional software platform. Therefore, the electronic seal in the technical solution of the present invention has strong anti-counterfeiting functionality when its seal pattern is printed onto paper.

The core solution of the present invention is using the mobile phone number as the basis for the associated code of authorized counterpart due to the following characteristics of mobile phone numbers. 1. Relatively authoritative third-party real-name authentication enables it relatively clear identity orientation. 2. Dynamic interaction functionality of information. 3. Face-to-face instant authentication, which includes at least two aspects: first, whether the relevant personnel are in real-time control or use of the mobile phone number—this can be confirmed by making a call in person; and second, whether the mobile phone number has obtained the authentication qualification of the authentication object—this can be verified by performing instant authentication through operating the mobile phone number in person. The instant dynamic identity confirmation and information interaction characteristics are unique to mobile phone numbers compared with other identity characteristic information. Other communication tool numbers also possess the above characteristics to a certain extent, but are far inferior to mobile phone numbers in reliability and convenience.

In terms of electronic seal anti-counterfeiting authentication, there are three levels of anti-counterfeiting. The first level is on-line network platform anti-counterfeiting authentication, which verifies the authenticity of a stamped sample by validating elements such as its electronic signature, timestamp, and hash value. This level of anti-counterfeiting is highly reliable but very inconvenient—equivalent to checking DNA, which is a commonly used method in prior art. The second level is off-line electronic scanning authentication, which requires the use of electronic devices with scanning capabilities to establish communication with the network backend to confirm the authenticity of the stamped sample—equivalent to checking an ID card. This level is relatively reliable but still inconvenient. The third level is the presentation of authentication elements on the electronic seal pattern in a directly visually readable form. This level enables the preliminary visual identification of authenticity without the aid of any tools, providing high convenience—similar to daily appearance recognition. Visual identification, further combined with electronic-level authentication of the authentication elements presented in the electronic seal pattern through the network backend, achieves high reliability and convenience. Therefore, the third level of electronic seal anti-counterfeiting has both convenience and reliability, making it the most practical. The third level of electronic seal anti-counterfeiting can be combined with the first level of on-line anti-counterfeiting method to achieve comprehensive electronic seal anti-counterfeiting functionality both on-line and off-line.

The paper-based visually identifiable anti-counterfeiting electronic seal in the technical solution of the present invention still has strong anti-counterfeiting functionality, namely visual anti-counterfeiting functionality, when its seal pattern is printed onto paper or published in cyberspace in the form of images. Combined with the electronic signature and timestamp technology that has been maturely applied on various on-line contract signing platforms, the electronic seal of the present invention can completely solve the problem of seal anti-counterfeiting in all application scenarios, both on-line and off-line, at both the electronic and paper levels. The paper-based visually identifiable anti-counterfeiting electronic seal of the present invention is a powerful extension of the service mode of current on-line contract signing platforms. The implementation method for a paper-based visually identifiable anti-counterfeiting electronic seal of the present invention is convenient to operate, reliable to use, and highly anti-counterfeiting, with strong application prospects, and can further promote the healthy and stable development of the internet economy.

### BRIEF DESCRIPTION OF THE DRAWINGS

The present invention is further described by reference to the accompanying drawings below.

FIG. 1 is a schematic diagram of a seal pattern for a paper-based visually identifiable anti-counterfeiting electronic seal according to the present invention, including an associated code of authorized counterpart displayed as “counterpart 13912345678”.

FIG. 2 is a schematic diagram of a seal pattern for a paper-based visually identifiable anti-counterfeiting electronic seal according to the present invention, including both an associated code of authorized counterpart displayed as “counterpart 13912345678” and an associated code of stamped sample displayed as “code 0001234”.

FIG. 3 is a schematic diagram of a seal pattern for a paper-based visually identifiable anti-counterfeiting electronic private seal for natural persons according to the present invention, including information about both an associated code of stamped sample and an associated code of authorized counterpart.

FIG. 4 is a schematic diagram of a seal pattern for another paper-based visually identifiable anti-counterfeiting electronic seal according to the present invention, simultaneously including an associated code of stamped sample, an associated code of authorized counterpart, and electronic seal authentication communication interface information.

FIG. 5 is a schematic diagram of a seal pattern for an electronic official seal with an annular affiliated information area according to the present invention.

FIG. 6 is a schematic diagram of a seal pattern for an electronic official seal with a rectangular affiliated information area according to the present invention.

FIG. 7 is one of the flowcharts illustrating the method for generating and using a paper-based visually identifiable anti-counterfeiting electronic seal according to the present invention.

FIG. 8 is one of the flowcharts illustrating the method for authenticating, extracting, or consulting a stamped sample of a paper-based visually identifiable anti-counterfeiting electronic seal according to the present invention.

### DETAILED DESCRIPTION

### Example 1

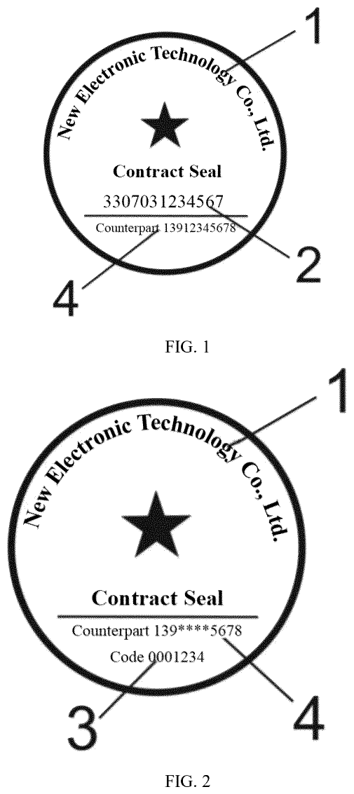

An implementation method for a paper-based visually identifiable anti-counterfeiting electronic seal of the present invention is achieved through electronic seal functional software. The electronic seal functional software is configured with an electronic seal authentication communication interface. In a case that a user needs stamping, the electronic seal functional software is operated to generate a seal pattern onto an electronic text to be stamped. The seal pattern of the paper-based visually identifiable anti-counterfeiting electronic seal includes a fixed information unit and a dynamic information unit. As shown in FIG. 1, the seal pattern of the paper-based visually identifiable anti-counterfeiting electronic seal includes a fixed information unit and a dynamic information unit. The fixed information unit includes a seal entity name 1, a five-pointed star logo of seal, a seal entity code 2, or a seal type name that is a contract seal. The dynamic information unit includes a set of associated codes of authorized counterpart 4, which in this example is displayed as “counterpart 13912345678”, representing a mobile phone number of an authorized counterpart. The associated code of authorized counterpart 4 is generated through the following method. An electronic seal operator submits mobile phone number information with exclusive characteristics of the authorized counterpart to the electronic seal functional software, which selects the submitted phone number information as the associated code of authorized counterpart 4, and fixedly presents the associated code of authorized counterpart 4 in a directly visually readable form within the generated seal pattern.

The associated code of authorized counterpart 4 presented in an indirectly visually readable form, such as a QR code or barcode, within the electronic seal pattern also has a certain off-line authentication function. However, due to lack of visually identifiable anti-counterfeiting functions, QR code is extremely inconvenient when managing and screening a large number of contract texts. It is more critical that the QR code is easy to forge, which is difficult to detect, resulting in difficulties in widespread acceptance by users at the application and operational level.

Using the exclusive communication tool number of the authorized counterpart as an authentication tool for stamped samples offers convenience and high reliability, with mobile phone numbers being particularly convenient and reliable. The specific authentication process for stamped samples is as follows. The authorized counterpart utilizes or operates a mobile phone number authenticated and associated with stamped samples to send an authentication request message to the electronic seal authentication communication interface of the electronic seal functional software according to specified requirements, with the request information including the seal entity name 1. The electronic seal functional software extracts the information of the mobile phone number through which the request is sent, and compares it with the information of the authenticated and associated mobile phone number of the authorized counterpart in the database. If it is a successful match, the identity authentication is completed, and the electronic seal functional software permits the authorized counterpart to initiate authentication, extraction or consultation on this or this batch of stamped samples. The electronic seal functional software responds to the mobile phone number that initiated the request by sending a message with the authentication, extraction, and consultation methods or websites for the stamped samples. In this example, the backend database will display all stamped samples under the authenticated and associated mobile phone number that match the seal entity name 1 for the authorized counterpart to select. If the above identity information does not match successfully, the electronic seal functional software rejects the request.

In this example, using the exclusive email address of the authorized counterpart as an authentication association tool is also a reliable and convenient preferred solution, but less convenient in authentication compared to using a mobile phone number.

Taking the email address as the authenticated and associated communication tool number information of the authorized counterpart as an example, the process is as follows. The authorized counterpart utilizes or operates an email address authenticated and associated with stamped samples to send an authentication request email to the electronic seal authentication communication interface of the electronic seal functional software according to specified requirements, with the request information including the seal entity name 1. The electronic seal functional software extracts the information of the email address through which the request is sent, and compares it with the information of the authenticated and associated email address of the authorized counterpart in the database. If it is a successful match, the identity authentication is completed, and the electronic seal functional software permits the authorized counterpart to initiate authentication, extraction or consultation on this or this batch of stamped samples. The electronic seal functional software responds to the email address that initiated the request by sending a mail with the authentication, extraction, and consultation methods or websites for the stamped samples. If the above email address information does not match successfully, the electronic seal functional software rejects the request.

Using instant messenger numbers such as WeChat ID, QQ number, and MSN number, as substitutes for mobile phone numbers can basically achieve similar functions. However, due to the additional steps required, such as following or adding as a friend, and the fact that interactive communication may not be conducted in real-time, the instant messenger numbers are inferior to mobile phone numbers in convenience and reliability.

### Example 2

An implementation method for a visually anti-counterfeiting electronic seal of the present invention is achieved through electronic seal functional software. The electronic seal functional software is configured with technical means such as identity authentication, electronic signature, timestamp, as well as an electronic seal authentication communication interface. As shown in FIG. 2, a seal pattern of the electronic seal includes a fixed information unit and a dynamic information unit. The fixed information unit includes a seal entity name 1, a five-pointed star logo of seal, and a seal type name that is a contract seal. The dynamic information unit includes an associated code of authorized counterpart 4 and an associated code of stamped sample 3. Both the associated code of authorized counterpart 4 and the associated code of stamped sample 3 are presented in a directly visually readable numeric code form. Compared with Example 1, only the first few and last few digits of the mobile phone number, rather than the full mobile phone number, are presented for the associated code of authorized counterpart 4, with the middle digits replaced by * or other symbols. This approach helps protect business secrets and the privacy of the counterpart to a certain extent, while minimally affecting the uniqueness and anti-counterfeiting characteristics of the electronic seal pattern.

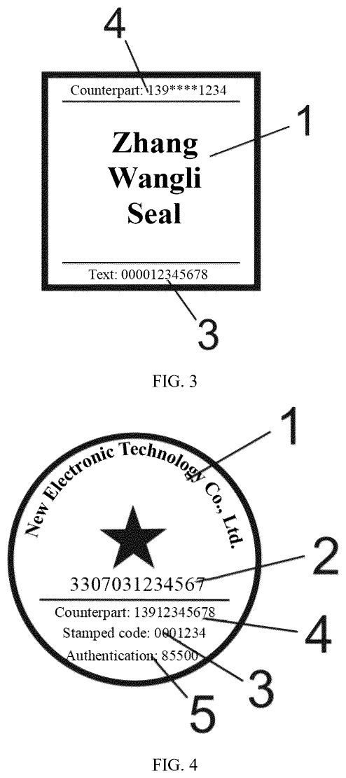

The same approach can also be applied to private seals of natural persons or special seals for legal representatives, as shown in FIG. 3. The seal pattern includes a natural person name, the associated code of authorized counterpart 4, and the associated code of stamped sample 3. If necessary, time information of stamping operation can also be added to the dynamic information unit.

The associated code of authorized counterpart 4 is generated through the following method. An operator extracts mobile phone number information of an authorized individual from stamped samples and inputs the same into a backend database, and authenticates and associates this mobile phone number information with the current stamped sample as a means of authentication for the qualification of authentication, extraction, or consultation of stamped samples. If there are multiple sets of associated mobile phone number information, one set or multiple sets of the associated codes of authorized counterpart 4 can be selected and displayed in a directly visually readable manner within the seal pattern. In this example, one set of mobile phone numbers is selected, and the first few digits and the last few digits of the mobile phone number are extracted to form the associated code of authorized counterpart 4. In this way, the associated code of authorized counterpart 4 serves as a set of secret codes, and only the person in possession of the mobile phone number or other informed individuals know the full mobile phone number. With this full mobile phone number, the qualification for authentication, extraction, or consultation of stamped samples can be obtained. For mobile phone number information that does not need to be displayed as the associated code of authorized counterpart 4 in the seal pattern, it can be added after the stamping operation. In this example, using an email address instead of a mobile phone number can offer a basically similar function.

The associated code of stamped sample 3 is generated through the following method. During the stamping operation, the electronic seal functional software automatically generates the associated code of stamped sample 3 for this or this batch of stamping operations, and associates the associated code of stamped sample 3 with the stamped sample. The associated code of stamped sample 3 can be a set of random numbers, or a number related to the cumulative number of times this electronic seal has been used, or time information of the stamping operation. The time information can serve as the basis information for the associated code of stamped sample 3 or be displayed independently within the electronic seal pattern. Using a number related to the cumulative number of times the electronic seal has been used or time information of a certain precision (such as precise to the minute or even second), enables the associated code of stamped sample 3, as a single element, a strong uniqueness characteristic.

The specific authentication process for stamped samples is as follows. The authorized counterpart utilizes or operates a mobile phone number authenticated and associated with stamped samples to send an authentication request message to the electronic seal authentication communication interface of the electronic seal functional software according to specified requirements, with the request information including the seal entity name 1 and the associated code of stamped sample 3. The electronic seal functional software extracts the information of the mobile phone number through which the request is sent, and compares it with the information of the authenticated and associated mobile phone number of the authorized counterpart in the database. If it is a successful match, the identity authentication is completed, and the electronic seal functional software permits the authorized counterpart to initiate authentication, extraction or consultation on this batch of stamped samples. The electronic seal functional software responds to the mobile phone number that initiated the request by sending a message with the authentication, extraction, and consultation methods or websites for the stamped samples. Compared with Example 1, this example provides precise authentication. The backend database will display to the authorized counterpart the stamped samples under the authenticated and associated mobile phone number that match both the seal entity name 1 and the associated code of stamped sample 3 for authentication, extraction, or consultation. If only the seal entity name 1 matches successfully but the associated code of stamped sample 3 does not, the electronic seal functional software platform will display to the authorized counterpart all the stamped samples associated with the seal entity name 1 under the mobile phone number for selection. If the above identity information does not match successfully, the electronic seal functional software rejects the request.

### Example 3

An implementation method for a paper-based visually identifiable anti-counterfeiting electronic seal of the present invention is managed by a third-party authentication authority. The third-party authentication authority is configured with an electronic seal functional software platform, which provides users with services for generating, saving, and authenticating electronic seals, and is configured with technical means such as identity authentication, electronic signature, and timestamp. The third-party electronic seal authentication authority establishes an electronic seal service relationship recognized by both parties with a seal entity unit, and establishes a database of identity information and electronic seal authentication information for the seal entity unit. The seal entity unit binds to a mobile communication number for sending or receiving electronic seal authentication information. The bound mobile communication number is registered in the database of identity information and electronic seal authentication information for the seal entity unit established by the third-party electronic seal authentication authority in advance. For seal entity users, an identity authentication mode in the form of a USB-Key can also be adopted.

As shown in FIG. 4, a seal pattern of the electronic seal includes a fixed information unit and a dynamic information unit. The fixed information unit includes a seal entity name 1, a five-pointed star logo of seal, and a seal entity code 2. The dynamic information unit includes an associated code of stamped sample 3 and an associated code of authorized counterpart 4. The generation methods for the associated code of authorized counterpart 4 and the associated code of stamped sample 3 are referred to Example 1 or 2. Both the associated code of stamped sample 3 and the associated code of authorized counterpart 4 are presented in a directly visually readable numeric code form. The associated code of authorized counterpart 4 in this example is a mobile phone number of an authorized counterpart. The seal pattern also includes authentication communication interface information 5, which can be in the form of a customer service phone number, email address, authentication website, instant messenger account, or social media account, etc. The authorized counterpart or other authorized personnel can establish communication with the electronic seal functional software platform through the electronic seal authentication communication interface to submit requests for authentication, extraction, or consultation of the corresponding stamped samples. Alternatively, n authentication authority identity characteristic mark can be used instead of the authentication communication interface information 5. In this case, the default authentication communication interface information 5 is associated with the authentication authority identity characteristic mark.

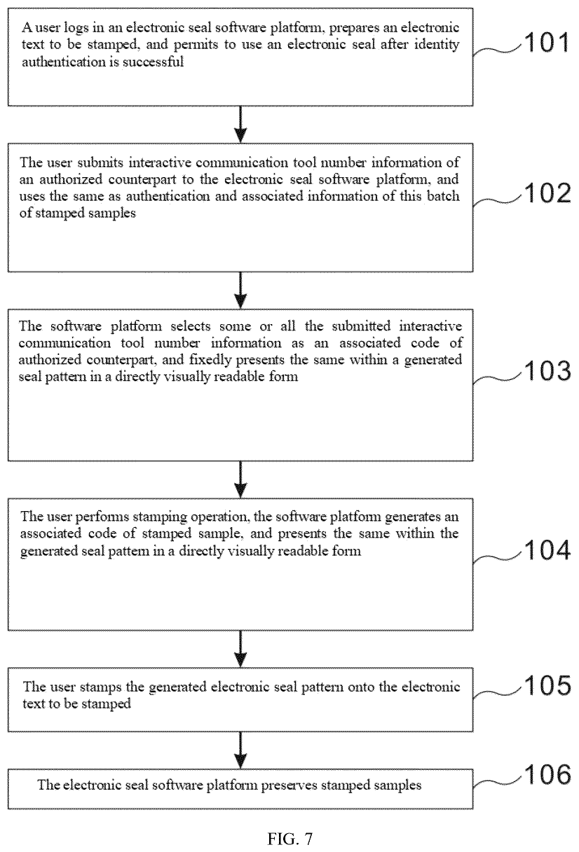

The generation and usage process of the electronic seal in this example as illustrated in FIG. 7, is detailed as follows.

Step 101: a user (electronic seal operator) logs in the electronic seal functional software platform, prepares an electronic text to be stamped, and after passing the identity authentication of the platform, is authorized to use the electronic seal. In practical use, the steps of preparation of the electronic text to be stamped and the identity authentication can be performed at any step before the stamping operation.

Step 102: the user (electronic seal operator) submits the interactive communication tool number information of the authorized counterpart to the electronic seal functional software platform, and uses the same as the authenticated and associated information for this batch of stamped samples.

Step 103: the electronic seal functional software platform selects some or all of the above-submitted interactive communication tool number information to form some or all of the associated code of authorized counterpart 4, and directly presents the generated associated code of authorized counterpart 4 in a visually readable form within the electronic seal pattern. In this example, this step can be specifically detailed as follows. The electronic seal functional software platform uses the whole submitted phone number as the associated code of authorized counterpart 4.

Step 104: the user (electronic seal operator) performs the stamping operation, and the electronic seal functional software platform generates an associated code of stamped sample 3, which is directly presented in a visually readable form within the electronic seal pattern.

Step 105: the user (electronic seal operator) stamps the generated seal pattern to the electronic text to be stamped.

Step 106: the electronic seal functional software platform (backend server, database, or operating computer) preserves the stamped samples formed after the stamping operation.

Incorporating the aforementioned steps as a whole or after being divided into additional electronic seal usage steps is also within the scope of protection of the present invention. For example, before or during identity authentication, the steps of identity authentication processes, electronic signature operations and retaining related data, and recording and saving timestamp data during the stamping operation can be performed.

The authorized counterpart of the stamped sample gains the right of authentication, extraction, or consultation of the stamped sample based on the phone number as the associated code of authorized counterpart 4. For those phone numbers of authorized counterparts that are not used as the associated code of authorized counterpart 4 but are registered in the database and have been authenticated and associated with stamped samples by the electronic seal operator, they can also serve as a basis for the authorized counterpart to obtain the right of authentication, extraction, or consultation of the associated stamped samples.

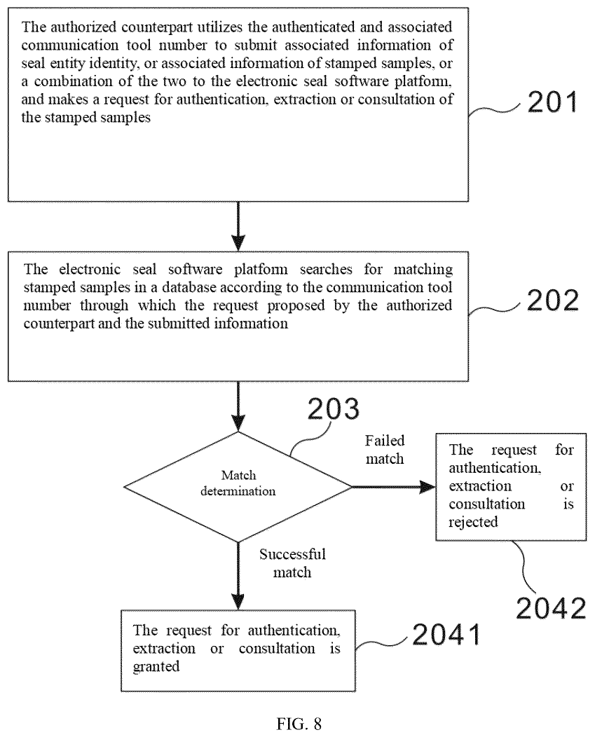

In a case that the authorized counterpart needs to authenticate, extract, or consult stamped samples, an authentication message is sent using the phone number displayed in the associated code of authorized counterpart 4 to the authentication service communication interface of the authentication authority, obtaining authorization for authenticating, extracting, or consulting the associated stamped samples. The specific method for authenticating, extracting, or consulting stamped samples, as illustrated in FIG. 8, includes the following steps.

Step 201: the authorized counterpart uses the authenticated and associated phone number to establish communication with the authentication communication interface of the electronic seal functional software platform, and submits a request for authentication, extraction, or consultation of stamped samples. The request includes information related to the seal entity identity, the associated code of stamped sample, or a combination of both. The information related to the seal entity identity is set according to specified requirements, such as the seal entity name, abbreviation, or identity code of the seal entity.

Step 202: the electronic seal functional software platform searches for matching stamped samples in a database based on the phone number used by the authorized counterpart and the submitted information.

Step 203: matching and determination, based on whether the matching is successful or not, step 2041 or step 2042 is performed, respectively. In this step, the phone number for making the request and the possession of corresponding authorization are prerequisites and necessary conditions for a successful match. Identity authentication of the authorized counterpart can be conducted firstly, that is, the phone number for making the request matches the authenticated and associated phone number of the authorized party in the database (alternatively, a dynamic message verification code can be used). After that, stamped samples that match the seal entity name or the associated code of stamped sample are searched for. Alternatively, matching searches can be conducted simultaneously for the combination of the phone number for making the request and the seal entity name or the associated code of stamped sample.

Step 2041: if the matching is successful, the electronic seal functional software platform permits the authorized counterpart to authenticate, extract, or consult the associated stamped samples. This step can be further detailed as follows. The electronic seal functional software platform sends a link and an extraction code for extracting the stamped samples to the phone number. The authorized counterpart logs in the link and enters the extraction code to extract all associated stamped samples.

Step 2042: if the matching fails, the request is denied.

For unauthorized individuals seeking to access these stamped samples, due to the lack of the authorized phone number, they are inaccessible to authentication, extraction, or consultation of the stamped samples. The some or all of the authorized phone number information of the authorized counterpart for the stamped samples are presented in the associated code of authorized counterpart 4 within the seal pattern, preventing attempts from illegally replicating the seal pattern. If someone attempts to copy the seal pattern verbatim, due to the lack of corresponding authorized phone number information, the duplication is easily exposed. Conversely, if the mobile phone number information of the copier is forcibly added to the seal pattern, the identity authentication cannot be passed by the electronic seal functional software platform. Therefore, the electronic seal of the technical solution in the present invention has a strong anti-counterfeiting function even after its pattern is printed onto paper. Combined with the mature on-line contract signing platform mode, the electronic seal in the present invention can comprehensively address the challenge of seal anti-counterfeiting across all application scenarios, both on-line and off-line, at both the electronic and paper levels.

In this example, a mobile phone number is selected as the associated code of authorized counterpart 4, with the full mobile phone number information being displayed. Alternatively, an email address can be used in place of the mobile phone number to essentially achieve the same functionality. Of course, other instant messenger numbers such as QQ number or WeChat ID can also be used to replace the mobile phone number in this example. However, in comparison, the mobile phone number offers significantly stronger identity verification capabilities, operational convenience, and manageability.

In this example, there is a distinction in permissions between authorized extractors and authorized consultants of stamped samples. The authorized consultants of stamped samples have only the right to consult rather than extracting the stamped samples. Additionally, the consulted electronic seal patterns of the stamped samples contain watermarks or have undergone deformation processing, allowing authorized consultants to conditionally discern the authenticity of the electronic seal while preventing the pattern from being copied.

When subsequent new authorized counterparts or external related persons need to authenticate, extract, or consult stamped samples, they must obtain authorization from the seal operator, and phone numbers, email addresses, or other communication tool information of the new authorized counterparts or external related persons are added to the list of the associated information of the authorized counterpart in the database. At this point, the phone numbers or email addresses of these new authorized counterparts fail to be displayed and are unnecessary to be displayed in the dynamic information unit of the seal pattern, but their authentication function remains the same as that of previously associated communication tool information of the authorized counterpart.

In another case, external related persons can obtain the qualification to authenticate, extract, or consult stamped samples through a sublicense granted by an authorized counterpart. A sublicensor of the authorized counterpart submits a request for authentication, extraction, or consultation of stamped samples to the electronic seal functional software platform. The submitted request information must include the mobile phone number or email address information authenticated and associated with the authorized counterpart, as well as the associated information of seal entity or associated code of stamped sample 3. The electronic seal functional software platform sends a dynamic verification code to the mobile phone number or email address authenticated and associated with the authorized counterpart and submitted by the sublicensor. The authorized counterpart forwards the received dynamic verification code to the sublicensor, and the sublicensor submits the received dynamic verification code to the electronic seal functional software platform. If a match is successful, the sublicense permission is completed, and the sublicensor obtains the authentication, extraction, or consultation rights to the associated stamped samples. The electronic seal functional software platform sends the methods for authenticating, extracting, or consulting the stamped samples to the sublicensor.

Another sublicensing method is as follows. After receiving the sublicensing request mentioned above, the electronic seal functional software platform sends a website link and file extraction code to the mobile phone number or email address authenticated and associated with the authorized counterpart and submitted by the sublicensor. The sublicensor logs in the website using the mobile phone number that received the sublicense information to authenticate, extract, or consult the stamped samples.

### Example 4

The electronic seal functional software is an electronic seal functional software platform provided by a third-party authentication authority, which offers services to users for generating, saving, and authenticating electronic seals, and is configured with technical means such as identity authentication, electronic signature, and timestamp. The third-party electronic seal authentication authority establishes an electronic seal service relationship recognized by both parties with a seal entity unit, and establishes a database of identity information and electronic seal authentication information for the seal entity unit. The seal entity unit binds to a mobile communication number for sending or receiving electronic seal authentication information. The bound mobile communication number is registered in the database of identity information and electronic seal authentication information for the seal entity unit established by the third-party electronic seal authentication authority in advance. For seal entity users, an identity authentication mode in the form of a USB-Key can also be adopted.

In a case that users need to use an electronic seal, they log in the electronic seal functional software platform and obtain authorization to use the seal through identity authentication or an electronic signature. The users open, import, input, or upload the electronic text to be stamped through the electronic seal functional software platform. By operating the platform, seal pattern is generated onto the electronic text.

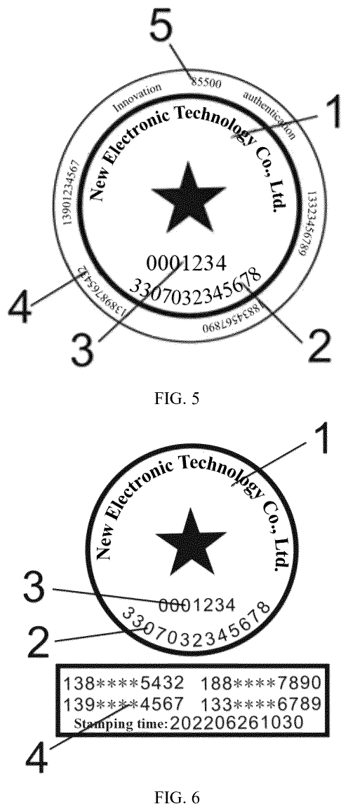

As shown in FIG. 5, the seal pattern of the paper-based visually identifiable anti-counterfeiting electronic seal includes a fixed information unit and a dynamic information unit. The fixed information unit includes a seal entity name 1, a seal entity code 2, a five-pointed star logo of seal, and either authentication communication interface information 5 of the third-party authentication authority, or an identity characteristic mark or code. The dynamic information unit includes an associated code of authorized counterpart 4 and an associated code of stamped sample 3. Both the associated code of authorized counterpart 4 and the associated code of stamped sample 3 are presented in a directly visually readable numeric code form. The generation methods for the associated code of authorized counterpart 4 and the associated code of stamped sample 3 are referred to Example 1 or 2.

The seal pattern generated by the anti-counterfeiting electronic seal includes, besides the main pattern, an affiliated information area. Information within the main pattern and information within the affiliated information area together form complete stamp anti-counterfeiting authentication information. The main seal pattern is a circular official seal, including the seal entity name 1, the five-pointed star logo of seal, and the seal entity code 2, which belong to the fixed information unit. Additionally, the main seal pattern includes an associated code of stamped sample 3 belonging to the dynamic information unit. The associated code of stamped sample 3 is formed based on the cumulative number of times the electronic seal has been used. The affiliated information area is an annular region formed outside the main circular seal pattern, including four sets of mobile phone numbers of the authorized counterpart for stamped samples. Furthermore, the affiliated information area includes a set of authentication authority identity codes 5, which is composed of the abbreviation and service telephone number of the third-party authentication authority.

The generation and usage process for the paper-based visually identifiable electronic seal as well as the method for authenticating, extracting, or consulting stamped samples in this example are referred to Example 1, Example 2, or Example 3.

### Example 5

As shown in FIG. 6, referring to Example 4, besides a main pattern, a seal pattern generated by the paper-based visually identifiable anti-counterfeiting electronic seal includes an affiliated information area. Information within the main pattern and information within the affiliated information area together form complete stamp anti-counterfeiting authentication information. The main seal pattern is a circular official seal, including a seal entity name 1, a five-pointed star logo of seal, and a seal entity code 2, which belong to the fixed information unit. Additionally, the main seal pattern includes an associated code of stamped sample 3 belonging to the dynamic information unit. The associated code of stamped sample 3 is formed based on the cumulative number of times the electronic seal has been used. The affiliated information area is a rectangular frame and includes four sets of mobile phone numbers of authorized counterpart for stamped samples and a set of time information during the stamping operation. This time information essentially constitutes another set of associated codes of stamped sample. The middle four digits of each of the four sets of mobile phone numbers are hidden, protecting the privacy of the authorized counterpart without affecting the functionality. The affiliated information area with rectangular frame of this example, after the frame is removed, becomes a typical amorphous affiliated information area.

1. An implementation method for a paper-based visually identifiable anti-counterfeiting electronic seal, achieved through electronic seal functional software, wherein in a case that a user needs stamping, the electronic seal functional software is operated to generate a seal pattern onto an electronic text to be stamped; the seal pattern of the paper-based visually identifiable anti-counterfeiting electronic seal comprises a fixed information unit and a dynamic information unit; the fixed information unit comprises one or more combinations of the following information: a seal entity name (1), a seal logo, a seal entity code (2), or a seal type name; the dynamic information unit comprises an associated code of authorized counterpart (4); and the associated code of authorized counterpart (4) is generated through the following method: submitting communication tool number information of an authorized counterpart by an electronic seal operator to the electronic seal functional software; and using the electronic seal functional software to select some or all of the submitted communication tool number information of the authorized counterpart to form part or all of the associated code of authorized counterpart (4), and to fixedly present the associated code of authorized counterpart (4) in a directly visually readable manner within the generated seal pattern or in an affiliated information area thereof.

2. The implementation method for a paper-based visually identifiable anti-counterfeiting electronic seal according to claim 1, wherein the communication tool number is a number with exclusive identity-oriented characteristics, comprising a mobile phone number, an email address, or an instant messenger number.

3. The implementation method for a paper-based visually identifiable anti-counterfeiting electronic seal according to claim 2, wherein information in the affiliated information area and a main seal pattern are generated and displayed synchronously, and may be printed synchronously onto paper.

4. The implementation method for a paper-based visually identifiable anti-counterfeiting electronic seal according to claim 1, wherein the electronic seal functional software preserves a seal pattern sample, stamped information summary, or stamped text formed after a stamping operation, the seal pattern sample, the stamped information summary, or the stamped text being collectively referred to as stamped samples; the electronic seal functional software is configured with an electronic seal authentication communication interface; the electronic seal functional software authenticates and associates a communication tool number serving as the information source basis for the associated code of authorized counterpart (4) with the stamped samples, or, the electronic seal functional software authenticates and associates the acquired communication tool number information of the authorized counterpart with the stamped samples; and by recognizing the authenticated and associated communication tool number information operated by the authorized counterpart, the electronic seal functional software grants the authorized counterpart the right to actively initiate authentication, extraction, or consultation of the stamped samples of this time or this batch.

5. The implementation method for a paper-based visually identifiable anti-counterfeiting electronic seal according to claim 2, wherein the electronic seal functional software preserves a seal pattern sample, stamped information summary, or stamped text formed after a stamping operation, the seal pattern sample, the stamped information summary, or the stamped text being collectively referred to as stamped samples; the electronic seal functional software is configured with an electronic seal authentication communication interface; the electronic seal functional software authenticates and associates a communication tool number serving as the information source basis for the associated code of authorized counterpart (4) with the stamped samples, or, the electronic seal functional software authenticates and associates the acquired communication tool number information of the authorized counterpart with the stamped samples; and by recognizing the authenticated and associated communication tool number information operated by the authorized counterpart, the electronic seal functional software grants the authorized counterpart the right to actively initiate authentication, extraction, or consultation of the stamped samples of this time or this batch.

6. The implementation method for a paper-based visually identifiable anti-counterfeiting electronic seal according to claim 3, wherein the electronic seal functional software preserves a seal pattern sample, stamped information summary, or stamped text formed after a stamping operation, the seal pattern sample, the stamped information summary, or the stamped text being collectively referred to as stamped samples; the electronic seal functional software is configured with an electronic seal authentication communication interface; the electronic seal functional software authenticates and associates a communication tool number serving as the information source basis for the associated code of authorized counterpart (4) with the stamped samples, or, the electronic seal functional software authenticates and associates the acquired communication tool number information of the authorized counterpart with the stamped samples; and by recognizing the authenticated and associated communication tool number information operated by the authorized counterpart, the electronic seal functional software grants the authorized counterpart the right to actively initiate authentication, extraction, or consultation of the stamped samples of this time or this batch.

7. The implementation method for a paper-based visually identifiable anti-counterfeiting electronic seal according to claim 4, wherein the authorized counterpart utilizes or operates the communication tool number authenticated and associated with the stamped samples or the communication tool number serving as the information basis for the associated code of authorized counterpart (4) to establish communication with the electronic seal functional software through the electronic seal authentication communication interface, and make a request for authentication, extraction, or consultation of the stamped samples; and upon receiving the request, the electronic seal functional software extracts the communication tool number information through which the request is proposed by the authorized counterpart, and determines whether there are stamped samples authenticated and associated with the number information, to decide whether to grant the request.

8. The implementation method for a paper-based visually identifiable anti-counterfeiting electronic seal according to claim 5, wherein the authorized counterpart utilizes or operates the communication tool number authenticated and associated with the stamped samples or the communication tool number serving as the information basis for the associated code of authorized counterpart (4) to establish communication with the electronic seal functional software through the electronic seal authentication communication interface, and make a request for authentication, extraction, or consultation of the stamped samples; and upon receiving the request, the electronic seal functional software extracts the communication tool number information through which the request is proposed by the authorized counterpart, and determines whether there are stamped samples authenticated and associated with the number information, to decide whether to grant the request.

9. The implementation method for a paper-based visually identifiable anti-counterfeiting electronic seal according to claim 6, wherein the authorized counterpart utilizes or operates the communication tool number authenticated and associated with the stamped samples or the communication tool number serving as the information basis for the associated code of authorized counterpart (4) to establish communication with the electronic seal functional software through the electronic seal authentication communication interface, and make a request for authentication, extraction, or consultation of the stamped samples; and upon receiving the request, the electronic seal functional software extracts the communication tool number information through which the request is proposed by the authorized counterpart, and determines whether there are stamped samples authenticated and associated with the number information, to decide whether to grant the request.

10. The implementation method for a paper-based visually identifiable anti-counterfeiting electronic seal according to claim 8, wherein the affiliated information area is a rectangular information area, an annular information area outside a main pattern of a circular or oval seal, or an irregularly shaped information area.

11. The implementation method for a paper-based visually identifiable anti-counterfeiting electronic seal according to claim 8, wherein the dynamic information unit further comprises an associated code of stamped sample (3), and the associated code of stamped sample (3) is generated through the following method: during the stamping operation, using the electronic seal functional software to automatically generate the associated code of stamped sample (3), and fixedly present the generated associated code of stamped sample (3) in a directly visually readable form within the generated seal pattern or in the affiliated information area thereof.

12. The implementation method for a paper-based visually identifiable anti-counterfeiting electronic seal according to claim 9, wherein the dynamic information unit further comprises an associated code of stamped sample (3), and the associated code of stamped sample (3) is generated through the following method: during the stamping operation, using the electronic seal functional software to automatically generate the associated code of stamped sample (3), and fixedly present the generated associated code of stamped sample (3) in a directly visually readable form within the generated seal pattern or in the affiliated information area thereof.

13. The implementation method for a paper-based visually identifiable anti-counterfeiting electronic seal according to claim 11, wherein the authorized counterpart utilizes or operates the communication tool number authenticated and associated with the stamped samples or the communication tool number serving as the information basis for the associated code of authorized counterpart (4) to establish communication with the electronic seal functional software through the electronic seal authentication communication interface, and make a request for authentication, extraction, or consultation of the stamped samples, with the request information comprising associated information of seal entity, the associated code of stamped sample (3), or a combination of the two; upon receiving the request, the electronic seal functional software extracts the communication tool number information through which the request is proposed by the authorized counterpart, and searches a database for stamped samples matching the above-mentioned associated elements in combination with the associated information of seal entity, the associated code of stamped sample (3), or the combination of the two submitted by the authorized counterpart; and if a match is found, the request is granted.

14. The implementation method for a paper-based visually identifiable anti-counterfeiting electronic seal according to claim 12, wherein the authorized counterpart utilizes or operates the communication tool number authenticated and associated with the stamped samples or the communication tool number serving as the information basis for the associated code of authorized counterpart (4) to establish communication with the electronic seal functional software through the electronic seal authentication communication interface, and make a request for authentication, extraction, or consultation of the stamped samples, with the request information comprising associated information of seal entity, the associated code of stamped sample (3), or a combination of the two; upon receiving the request, the electronic seal functional software extracts the communication tool number information through which the request is proposed by the authorized counterpart, and searches a database for stamped samples matching the above-mentioned associated elements in combination with the associated information of seal entity, the associated code of stamped sample (3), or the combination of the two submitted by the authorized counterpart; and if a match is found, the request is granted.

15. The implementation method for a paper-based visually identifiable anti-counterfeiting electronic seal according to claim 13, wherein a sublicensor of the authorized counterpart submits a request for authentication, extraction, or consultation of stamped samples to the electronic seal functional software; the request information submitted has to comprise the communication tool number information authenticated and associated with the stamped samples of the authorized counterpart or the communication tool number information serving as the information basis for the associated code of authorized counterpart (4), and comprise one of the following information or a combination of both: the associated information of seal entity or the associated code of stamped sample (3); upon receiving the request, the electronic seal functional software extracts the communication tool number information of the authorized counterpart from the request information and searches the database for associated and matching stamped samples in combination with the associated information of seal entity, the associated code of stamped sample (3), or the combination of both in the request information; if matching stamped samples are found, the electronic seal functional software sends sublicense confirmation information to the communication tool number of the authorized counterpart; the authorized counterpart forwards the received confirmation information to the sublicensor; the sublicensor uses the received confirmation information to submit a sublicense qualification matching request to the electronic seal functional software; the electronic seal functional software performs matching determination; if the match is successful, the sublicense permission is completed, and the sublicensor obtains the right to authenticate, extract, or consult the associated stamped samples.

16. The implementation method for a paper-based visually identifiable anti-counterfeiting electronic seal according to claim 14, wherein a sublicensor of the authorized counterpart submits a request for authentication, extraction, or consultation of stamped samples to the electronic seal functional software; the request information submitted has to comprise the communication tool number information authenticated and associated with the stamped samples of the authorized counterpart or the communication tool number information serving as the information basis for the associated code of authorized counterpart (4), and comprise one of the following information or a combination of both: the associated information of seal entity or the associated code of stamped sample (3); upon receiving the request, the electronic seal functional software extracts the communication tool number information of the authorized counterpart from the request information and searches the database for associated and matching stamped samples in combination with the associated information of seal entity, the associated code of stamped sample (3), or the combination of both in the request information; if matching stamped samples are found, the electronic seal functional software sends sublicense confirmation information to the communication tool number of the authorized counterpart; the authorized counterpart forwards the received confirmation information to the sublicensor; the sublicensor uses the received confirmation information to submit a sublicense qualification matching request to the electronic seal functional software; the electronic seal functional software performs matching determination; if the match is successful, the sublicense permission is completed, and the sublicensor obtains the right to authenticate, extract, or consult the associated stamped samples.

17. The implementation method for a paper-based visually identifiable anti-counterfeiting electronic seal according to claim 13, wherein the electronic seal functional software is an electronic seal functional software platform managed by a third-party authentication authority.

18. The implementation method for a paper-based visually identifiable anti-counterfeiting electronic seal according to claim 15, wherein the electronic seal functional software is an electronic seal functional software platform managed by a third-party authentication authority.

19. The implementation method for a paper-based visually identifiable anti-counterfeiting electronic seal according to claim 17, wherein the seal pattern or the affiliated information area thereof of the paper-based visually identifiable anti-counterfeiting electronic seal further comprises associated mark information or authentication communication interface information (5) of an electronic seal authentication authority.

20. The implementation method for a paper-based visually identifiable anti-counterfeiting electronic seal according to claim 17, wherein the paper-based visually identifiable anti-counterfeiting electronic seal is used in combination with identity authentication, electronic signatures, or timestamp technology of the seal entity, seal operator, and all related parties.
